(19) United States
(12) Patent Application Publication
(10) Pub. No.: US 2019/0375339 A1
(43) Pub. Date: Dec. 12, 2019

(54) HEADREST AND SEAT ASSEMBLY CONFIGURABLE TO ALLOW FOR LONG ITEM HAULING

(71) Applicant: FORD GLOBAL TECHNOLOGIES, LLC, Dearborn, MI (US)

(72) Inventors: Nicholas Anthony Colarossi, Saline, MI (US); Adam Bangerter, Dearborn, MI (US); Kevin Mozurkewich, Livonia, MI (US)

(21) Appl. No.: 16/005,225

(22) Filed: Jun. 11, 2018

(51) Int. Cl. B60R 11/00; B60N 2/856; B60N 2/879

(52) U.S. Cl. CPC B60R 11/00; B60N 2/856; B60R 2011/0082; B60R 2011/0017; B60R 2011/0071; B60N 2/879

(57) ABSTRACT

A headrest includes a body, having a wall, a cargo channel in the wall and a tie-down feature carried on the body. The headrest may be incorporated into a seat assembly including a seat bottom, a seat back and the headrest carried on the seat back. The headrest and seat assembly are useful in a method of transporting cargo in a motor vehicle including, particularly, a long cargo item.

### TECHNICAL FIELD

This document relates generally to the motor vehicle equipment field and, more particularly, to a headrest and seat assembly that may be configured to meet user needs for hauling of long items such as lumber, pipes, tubing, fishing rods and the like.

### BACKGROUND

Manufacturers offer pickup trucks in a number of configurations and with a number of different bed lengths. For example, a crew cab pickup truck having a passenger compartment with a rear seat and capacity for five individuals may be configured with a cargo bed that is 1.524 meters (five feet) in length, 1.98 meters (6.5 feet) in length or 2.44 meters (eight feet) in length. For those opting for the shorter bed, there will be times where they still need to the ability to haul longer cargo items such as lumber, pipes (such as polyvinyl chloride (PVC) pipes), tubing (such as copper tubing), fishing rods and the like. Since such long cargo items are longer than the truck bed, the user may need to open the back window of the crew compartment to allow the items to route through the window and into the interior of the crew compartment.

This document relates to a new and improved headrest and new and improved seat assembly that may be quickly and conveniently configured to receive and hold a long cargo item and thereby aid in the hauling of a long cargo item in a safe and secure manner.

### SUMMARY

In accordance with the purposes and benefits as described herein, a new and improved headrest is provided. That support comprises (a) a body, including a wall, (b) a cargo channel in that wall, and (c) a tie-down feature carried on the body.

More particularly, the body includes a first face and a second face and the wall is provided in the first face. The body may also include a first end and a second end. The tie down feature may include a first tie-down on the first end and a second tie-down on the second end.

The wall, and more particularly the cargo channel in the wall may include a first sidewall section, a second sidewall section and a bottom wall section lined with a wear-resistant material. That wear-resistant material may be selected from a group of materials consisting of plastic, fabric and combinations thereof. In one or more of the many possible embodiments of the headrest, the first tie-down may be a first hook and the second tie-down may be a second hook.

In accordance with an additional aspect, a new and improved seat assembly is provided for a motor vehicle. That seat assembly comprises a seat bottom, a seat back and a headrest carried on the seat back. The headrest includes (a) a body having a wall, (b) a cargo channel in that wall and (c) a tie-down feature carried on the body.

That body may include a first face and a second face and the wall may be provided in the first face. The body may also include a first end and a second end.

The tie-down feature may include a first tie-down on the first end of the body of the headrest and a second tie-down on the second end of the body of the headrest. The wall and, more particularly, the cargo channel in the wall may include a first sidewall section, a second sidewall section and a bottom wall section. The first sidewall section, the second sidewall section and the bottom wall section may all be lined with a wear resistant material. That wear resistant material may be selected from a group of materials consisting of plastic, fabric and combinations thereof.

In at least one or more of the many possible embodiments of the seat assembly, the first sidewall section and the second sidewall section are both V-shaped in cross section. In one or more of the many possible embodiments of the seat assembly, the first tie-down may be a first hook and the second tie-down may be a second hook.

Consistent with yet another aspect, a method is provided for transporting cargo in a motor vehicle. That method comprises the steps of (a) positioning the cargo, such as a long item of cargo, across a cargo channel provided in a body of the headrest and (b) extending a tie across the cargo from a first tie down on the body at a first side of the cargo channel to a second tie-down on the body at a second, opposite side of the cargo channel.

More particularly, the method may also include the step of folding the headrest to orient the cargo channel upward for receiving and holding the cargo prior to positioning the cargo across the cargo channel. In addition, the method may include the step of removing the tie from at least the first tie-down and the step of removing the cargo from the cargo channel after removing the tie.

In the following description, there are shown and described several preferred embodiments of the headrest, the seat assembly and the related method of transporting cargo in a motor vehicle. As it should be realized, the headrest, the seat assembly and the method are capable of other, different embodiments and their several details are capable of modification in various, obvious aspects all without departing from the headrest, seat assembly and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the headrest, the seat assembly and the related method of transporting cargo in a motor vehicle and together with the description serve to explain certain principles thereof.

FIG. 1 is a perspective view of the new and improved seat assembly illustrating the new and improved headrest of that seat assembly positioned in a first angular orientation adapted for supporting the neck of a passenger sitting in the middle seat position.

FIG. 2a is a view similar to FIG. 1 but illustrating the headrest positioned in a second orientation wherein the headrest is tilted forward to orient a cargo channel in a wall thereof upward for receiving and holding a long item of cargo held in place in the cargo channel by a tie extending between two opposed tie downs on the body of the headrest.

FIG. 2b is a detailed front elevational view of the long item cargo held in place in the cargo channel by the overlying tie.

FIG. 3 is a detailed front elevational view of the headrest illustrating the cargo channel in the first wall thereof and the two tie downs at each end of the headrest outboard of the cargo channel.

Reference will now be made in detail to the present preferred embodiments of the headrest, the seat assembly and the method of transporting cargo in a motor vehicle, examples of which are illustrated in the accompanying drawing figures.

### DETAILED DESCRIPTION

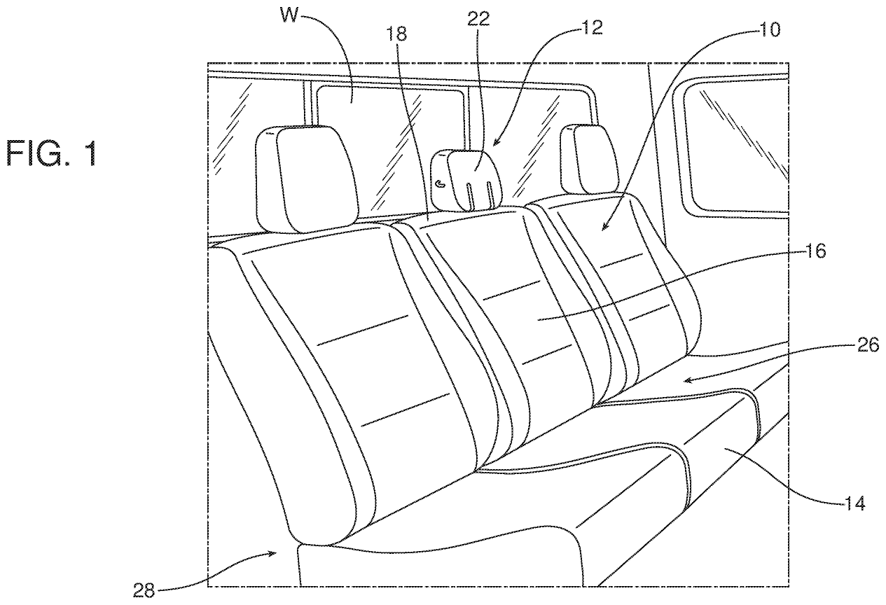

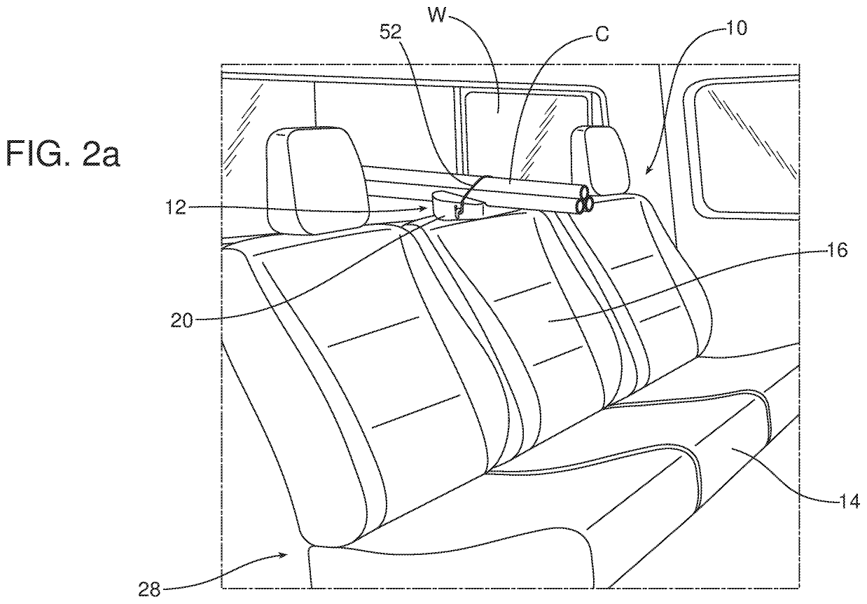

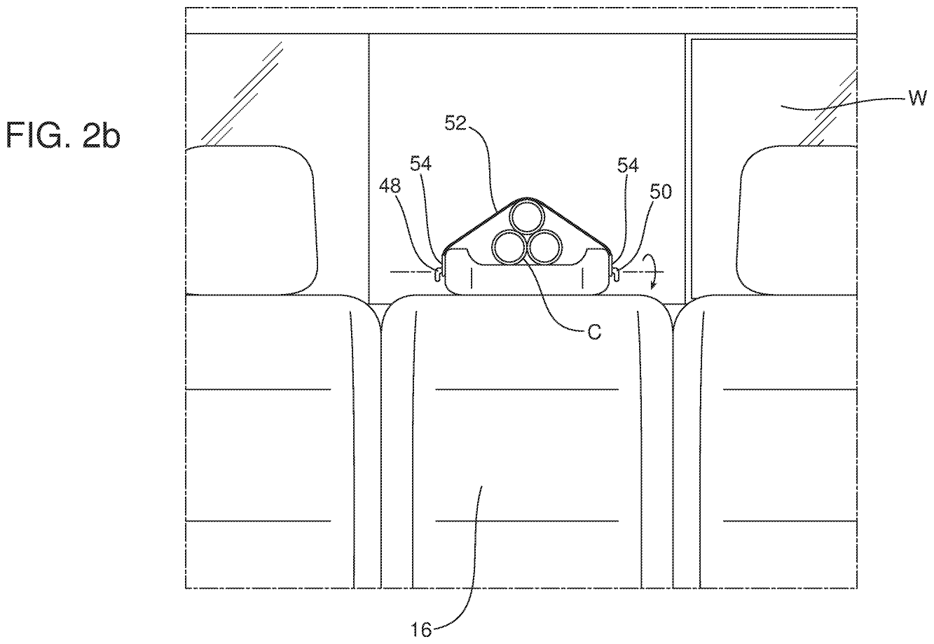

Reference is now made to FIGS. 1, 2a and 2b illustrating a new and improved seat assembly 10 that incorporates a new and improved headrest 12 adapted or configured to receive and hold a long item of cargo C such as the illustrated pipes shown in FIGS. 2a and 2b. The seat assembly includes a seat bottom 14, a seat back 16 connected to the seat bottom and the headrest 12 carried on the top 18 of the seat back 16.

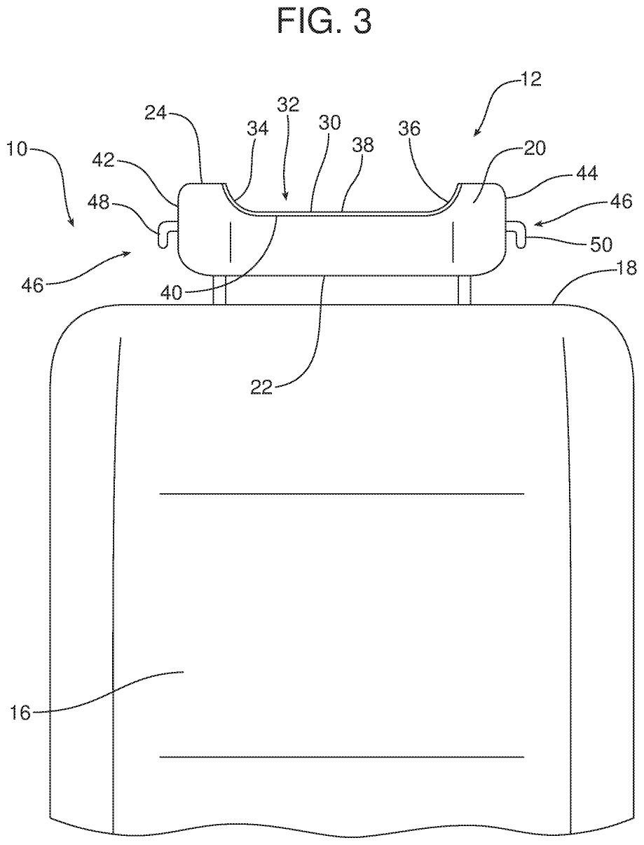

As best illustrated in FIG. 3, the headrest 12 includes a body 20 having a front or first face 22 and a rear or second face 24. The headrest 12 is configurable or displaceable between a first or home position illustrated in FIG. 1 and a second or cargo carrying position illustrated in FIGS. 2a and 2b. More specifically, in the first or home position, the first face 22 of the headrest 12 is oriented motor vehicle forward in a position to support the neck or head of one riding in the middle seat 26 of the rear seat 28 of a crew cab pickup truck as illustrated in FIGS. 1, 2a and 2b. Toward this end, the first face 22 may include a cushion for the added comfort of the seat occupant.

In the second position, the headrest 12 is tilted or pivoted forward so that the second face is oriented upward. As best illustrated in FIG. 3, that second face 24 includes a wall 30 that defines a cargo channel 32. Toward this end the wall 30 includes a first sidewall section 34, a second sidewall section 36 and a bottom wall section 38 between the first and second sidewall sections.

As further illustrated in FIG. 3, the first sidewall section 34, second sidewall section 36 and bottom wall section 38 of the wall 30 include a liner 40 of a wear-resistant material that provides a more rugged surface for supporting long items of cargo C as illustrated in FIGS. 2a and 2b. That wear resistant material may be selected from a group of materials consisting of plastic, fabric and combinations thereof. For some applications wear-resistant materials with non-skid properties are desired. While not shown, the liner 40 may also include treads or other structures to help grip any cargo C held thereon.

As further illustrated in FIG. 3, the body 20 of the headrest 12 also includes a first end 42 and a second end 44. In addition, a tie down feature, generally designated by reference numeral 46 is carried on the body 20. More particularly, in the illustrated embodiment, the tie-down feature 46 includes a first tie-down 48 and a second tie-down 50. More particularly, as shown in FIG. 3, the first tie-down 48 may comprise a first hook and the second tie down 50 may comprise a second hook. As should be appreciated, the first tie-down 48 and the second tie-down 50 are provided on the respective first and second ends 42, 44 of the body 20 outboard of the first and second sidewall sections 34, 36 of the wall 30 defining the cargo channel 32.

The new and improved seat assembly 10, and new and improved headrest 12 incorporated therein are useful in a method of transporting cargo C, such as the long item cargo illustrated in FIGS. 2a and 2b. After opening the sliding rear window section W, that method includes the step of folding the headrest 12 forward to orient the cargo channel 32 in the wall 30 of the second face 24 of the headrest 12 upward (as illustrated in FIGS. 2a, 2b and 3) for receiving and holding the cargo C. This is followed by the step of positioning the cargo C across the cargo channel 32.

Next is the step of extending a tie 52, such as a bungee cord, across the cargo C so that the tie extends from the first tie-down 48 on the body 20 at a first side of the cargo channel 32 to the second tie-down 50 on the body at a second side of the cargo channel. More particularly, the hooks 54 at the two opposite ends of the tie 52 may be connected to the two tie-downs 48, 50 at the opposite ends 42, 44 of the body 20.

One may then transport long items of cargo C, having a length greater than the cargo bed of the motor vehicle, to a desired destination in a safe and convenient manner without having to lower the tailgate of the cargo bed. Upon reaching the desired destination the method further includes the step of removing the tie 52 from at least the first tie-down 48. This is followed by the step of removing the cargo C from the cargo channel 32. If desired, the headrest 12 may then be tilted rearward and returned to the home position illustrated in FIG. 1.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A headrest, comprising:
a body including a wall extending between a first lateral end and a second lateral end;
a continuous, open-ended cargo channel in said wall between said first lateral end and said second lateral end; and
a tie down feature carried on said body.

2. The headrest of claim 1, wherein said body includes a first face and a second face and said wall is provided in said second face.

3. (canceled)

4. The headrest of claim 2, wherein said tie down feature includes a first tie down on said first lateral end and a second tie down on said second lateral end.

5. The headrest of claim 4, wherein said wall includes a first sidewall section, a second sidewall section and a bottom wall section lined with a wear-resistant material.

6. The headrest of claim 5, wherein said wear-resistant material is selected from a group of materials consisting of plastic, fabric and combinations thereof.

7. (canceled)

8. The headrest of claim 4, wherein said first tie down is a first hook and said second tie down is a second hook.

9. A seat assembly for a motor vehicle, comprising:
a seat bottom;
a seat back; and
a headrest carried on said seat back, said headrest including (a) a body including a wall extending between a first lateral end and a second lateral end, (b) a continuous, open-ended cargo channel in said wall between said first lateral end and said second lateral end and (c) a tie down feature carried on said body.

10. The seat assembly of claim 9, wherein said body includes a first face and a second face and said wall is provided in said second face.

11. (canceled)

12. The seat assembly of claim 10, wherein said tie down feature includes a first tie down on said first lateral end and a second tie down on said second lateral end.

13. The seat assembly of claim 12, wherein said wall includes a first sidewall section, a second sidewall section and a bottom wall section lined with a wear-resistant material.

14. The seat assembly of claim 13, wherein said wear-resistant material is selected from a group of materials consisting of plastic, fabric and combinations thereof.

15. (canceled)

16. The seat assembly of claim 12, wherein said first tie down is a first hook and said second tie down is a second hook.

17-20. (canceled)
